(19) United States
(12) Patent Application Publication
(10) Pub. No.: US 2019/0341735 A1
(43) Pub. Date: Nov. 7, 2019

(54) LASER MEDIUM FOR A SOLID-STATE LASER

(71) Applicant: Schott AG, Mainz (DE)

(72) Inventor: Dirk Apitz, Lausanne (CH)

(73) Assignee: Schott AG, Mainz (DE)

(21) Appl. No.: 16/514,510

(22) Filed: Jul. 17, 2019

Related U.S. Application Data
(63) Continuation-in-part of application No. PCT/EP2018/051300, filed on Jan. 19, 2018.

(30) Foreign Application Priority Data
Jan. 19, 2017 (DE) 10 2017 101 004.1

(51) Int. Cl. H01S 3/06; H01S 3/17

(52) U.S. Cl. CPC H01S 3/0615; H01S 3/175; H01S 3/0606; H01S 3/1618; H01S 3/0617; H01S 3/061; H01S 3/0621

(57) ABSTRACT

A laser medium, for generating laser light, that includes a light exit surface through which the laser light exits from the laser medium during laser operation. The light exit surface has a boundary which is defined by at least one chamfer or groove.

### CROSS REFERENCE TO RELATED APPLICATIONS

This is a continuation of PCT application No. PCT/EP2018/051300, entitled “LASER MEDIUM FOR A SOLID-STATE LASER”, filed Jun. 19, 2018, which is incorporated herein by reference.

### BACKGROUND OF THE INVENTION

### 1. Field of the Invention

The present invention relates to the field of solid-state laser media for generating laser light by stimulated emission of photons.

### 2. Description of the Related Art

Solid-state laser media, often in the form of laser rods, are used as light-amplifying components in solid-state lasers. A solid-state laser is generally constructed in such a way that a laser rod is arranged in an optical resonator and is irradiated with so-called pump light in order to excite higher energy levels. In this case, the resonator serves for feeding back photons emitted during the transition from the higher energy levels to lower levels, such that said photons can pass through the laser rod repeatedly and the probability of the occurrence of induced, i.e. stimulated, emission, is increased.

A laser resonator can be realized for example with two mirrors situated opposite one another, wherein one of the mirrors has a reflectivity of almost one hundred percent (end mirror) and the other mirror has a lower reflectivity in order to allow part of the laser light to exit from the resonator as a focused laser beam (output coupling mirror).

Usually the laser light additionally passes through an aperture or is delimited by an aperture stop in order, depending on the application, to bring about specific beam properties, in particular to support the formation of desired beam diameters, beam divergences or beam profiles and to suppress parasitic oscillations.

An aperture stop can be arranged for example as a further component in the beam path upstream of the output coupling mirror. By way of such an aperture stop, the laser light exiting from the laser medium can be selected very flexibly, in particular by way of a choice of the aperture shape and by way of the positioning of the aperture stop relative to the laser medium. Sometimes, even a lateral offset of the aperture relative to the laser medium may be desired in order to select light in accordance with the pump energy density in the laser medium. This is associated with the fact that the energy density in the laser medium in most cases is not homogenous and is often not even rotationally symmetrical or mirror-symmetrical.

On the other hand, it is also possible to dispense with aperture stops as separate components. Aperture stops or apertures can then be defined in particular by the geometric boundary of components already present, in some cases e.g. actually by the diameter of a laser rod itself. This has a number of advantages, for example that additional components and costs are saved, that the assembly of a solid-state laser is facilitated, a more compact design is made possible, and that the desired beam properties can be influenced in a defined manner as early as in the context of fabricating the laser medium.

What is disadvantageous about dispensing with separate aperture stops, however, is typically the fact that the above-described flexible selection of desired light portions is greatly limited. The cause of this is that the geometry of a laser medium, to a significantly greater extent than the geometry of a separate aperture stop, is also dependent on considerations other than just the light selection. In this regard, the geometry of the laser rods is intended e.g. also to have optimum entrance surfaces for pump light, and to ensure fabrication as expediently as possible, high stability and simple and safe installation.

EP 1 341 271 A1 is concerned with a laser device comprising a laser rod on the basis of Nd:YAG. In that case, the laser rods used have comparatively large dimensions, for example a diameter of 6 mm or more. Particularly small laser media are thus unrealizable.

DE 102 22 852 A1 also discusses various structures of an optical device comprising an optical component in which stray light is intended to be blocked. An elongate optical component which appears to have a notch on the lateral surface is proposed.

What is needed in the art is a laser medium that can take account of the abovementioned factors optimally when choosing the geometry of the laser rods, but at the same time can dispense with separate aperture stops and nevertheless enable a very flexible selection of desired light portions.

### SUMMARY OF THE INVENTION

The present invention provides laser media, in particular laser rods, which by virtue of their very geometry define a specific aperture and aperture stop for bringing about desired beam properties, wherein at the same time a particularly high flexibility is ensured in the case of light selection, in particular also with regard to the energy density in the laser medium, and wherein, moreover, the geometry of the laser media is able to be chosen optimally in regard to pump light surfaces, stability and mounting.

The invention should also specify for the laser medium a material which has outstanding optical properties, on the one hand, but on the other hand also enables cost-effective production. In this case, the intention is also to make it possible, in particular, to provide particularly small dimensions of the laser medium and to produce for example laser rods having a diameter of less than 6 mm.

An aspect of the present invention provides laser media which can be used in solid-state lasers, without aperture stops being required as separate components.

The invention provides a laser medium for generating laser light, wherein the laser medium is in a solid state and wherein the laser medium comprises a light exit surface, through which the laser light exits from the laser medium during laser operation, wherein the light exit surface has a boundary which is defined by at least one chamfer or groove.

The laser medium, embodied in particular as a laser rod, can accordingly have at least one, preferably only one, light exit surface, which transitions at the edge into a chamfer or a groove embodied as a fold.

In the case of a chamfer, the transition from the light exit surface to the adjoining chamfer surface is embodied in particular as an obtuse angle. The chamfer surface then has in turn in particular an obtuse-angled transition to a side surface of the laser medium.

The (obtuse) angle between the light exit surface and the chamfer surface or the chamfer surface and e.g. a side surface should be understood above to be the angle lying within the laser medium. The angle is preferably at least 100 degrees, particularly preferably at least 120 degrees and even more preferably at least 130 degrees and/or preferably at most 170 degrees, particularly preferably at least 120 degrees and at most 150 degrees and even more preferably at least 130 degrees and at most 140 degrees. The angle is for example in the range of at least 100 degrees and at most 170 degrees, particularly preferably at least 120 degrees and at most 150 degrees and even more preferably at least 130 degrees and at most 140 degrees.

Sometimes the (acute) supplementary angle with respect to the angle referred to above, i.e. the supplementary angle to form 180 degrees, is also used to describe a chamfer. In this description, the chamfer accordingly preferably has an angle of at least 10 degrees, particularly preferably at least 30 degrees and even more preferably of at least 40 degrees and/or at most 80 degrees, particularly preferably at most 60 degrees and even more preferably at most 60 degrees. By way of example, the angle is in the range of 10 to 80 degrees, particularly preferably in the range of 30 to 60 degrees and even more preferably in the range of 40 to 60 degrees.

In other words, the light exit surface can be bounded by a chamfer or groove. Provision can thus be made for at least one edge bounding the light exit surface not to form a direct transition to a lateral surface of the laser medium. Rather, preferably at least two successive edges first form the transition to the side or lateral surface. In this case, the term groove encompasses a fold, in particular. Furthermore, the term chamfer is intended also to include a hollow channel or a rounded portion, etc. A chamfer having a planar chamfer surface extending obliquely with respect to the light exit surface and/or side or lateral surface is preferred, however, in particular for fabrication reasons.

Depending on the shape of the light exit surface, e.g. quadrilateral, a plurality of chamfer surfaces can also be provided, e.g. one each for each of the four quadrilateral sides or edges of the light exit surface, or else, e.g. in the case of a round light exit surface, a completely circumferential chamfer surface.

Accordingly, provision is made, in particular, for the light exit surface to have a boundary on all sides which is defined by the at least one chamfer or groove. Accordingly, the light exit surface can be bounded on all sides by a chamfer or groove. The light exit surface is then bounded e.g. all around by an edge having an obtuse angle.

However, the fact that the light exit surface, according to the invention, has a boundary which is defined by at least one chamfer or groove does not necessarily presuppose that the boundary of the light exit surface adjoins the chamfer or the groove. In this regard, e.g. (instead of a groove embodied as a fold) a groove embodied as a slot can be provided, the projection of which along the optical axis defines the boundary of the light exit surface. In other words, it is not necessary for the boundary of the light exit surface to be formed by an edge. The light exit surface can accordingly e.g. also be a partial surface of the end face of the laser medium whose boundary is defined in particular by a chamfer or groove removed along the optical axis. A chamfer or groove adjoining the light exit surface is preferred, however, for fabrication reasons.

Of course, the boundary, i.e. the edge, of the light exit surface can also be defined by both at least one chamfer and at least one groove, i.e. generally by one or a plurality of chamfers and/or grooves.

By virtue of the fact that the light exit surface, according to the invention, has a boundary which is defined by at least one chamfer or groove, it is advantageously possible to achieve virtually any desired shape for the light exit surface. By way of example, a laser rod having a square cross-sectional area, after the at least one chamfer or groove has been provided, can have a non-square, e.g. a rectangular, a round, or else a laterally offset, optionally also square, light exit surface. The laser surfaces can thus have any desired shapes. Accordingly, a high flexibility regarding the shape of the light exit surface is made possible in a surprisingly simple manner.

At the same time, the geometry of the laser medium is able to be chosen substantially independently of the shape of the light exit surface. By way of example, a laser rod having a square cross section and a round light exit surface or else a laser rod having a round cross section and an angular light exit surface can be produced in a simple manner. The geometry of the laser medium is thus able to be chosen in particular with regard to further requirements; by way of example, a design having an angular, typically square, cross section can be chosen, which can afford some practical advantages, e.g. low production costs, simpler and stabler mounting with pump diodes and heat sinks, etc.

During laser operation, the light exit surface can additionally serve as an aperture and the at least one chamfer or groove can act as an aperture stop, such that a specific beam profile can be shaped. The light exit surface and respectively the chamfer or groove can thus serve for support when forming specific beam profiles.

The shape and position of the light exit surface, which are able to be chosen virtually freely and independently of the geometry of the laser medium, thus also enable a very flexible selection of desired light portions, in a manner similar to that in the case of a separately used and laterally positionable aperture shaped in any desired way. Advantageously, however, a separate aperture stop (pinhole stop) is not actually required. Apertures and/or aperture stops elsewhere in a laser system can thus be obviated and the entire laser system can thus become smaller, more compact and lighter. Furthermore, production costs can be reduced. Moreover, as early as during the production of the laser rod, a light exit surface serving as an aperture can be produced such that desired beam properties are obtained. In this regard, by way of example, the beam quality can be further improved.

In particular, the midpoint of the light exit surface can be laterally offset with respect to the optical axis of the laser rod, thereby enabling a light selection with regard to an inhomogeneous energy density in the laser medium.

The invention also makes it possible to reduce the susceptibility to faults during the assembly of lasers since the laser medium itself can already comprise optimum aperture shapes, determined e.g. by computer simulation, for specific purposes. With a chamfer, in particular, the fracture toughness of the laser media is furthermore advantageously increased because e.g. an obtuse angle is comparatively insensitive.

The at least one chamfer or groove can accordingly serve as an aperture stop, i.e. in particular serve to prevent laser light from leaving the laser rod via chamfer or groove surfaces. Furthermore, light can be scattered at the chamfer or the groove. In the resonator, therefore, preferably where the chamfer or groove is situated, no laser modes parallel to the optical axis can build up oscillations.

The at least one chamfer or groove can furthermore serve to influence the mode profile during laser operation in a defined manner in order to bring about specific beam properties of the laser light and/or to improve the beam quality of the laser light.

A targeted influencing of the build-up of oscillations of modes can be calculated a priori e.g. by way of computer simulations and taken into account in the shaping of the chamfer or groove.

In one embodiment of the present invention, the laser medium has a longitudinal axis, in particular is embodied as a laser rod having a first end face comprising the light exit surface, a second end face opposite the first end face, and a lateral surface.

The first end face may form the light exit surface. The laser medium can accordingly have in particular the shape of a chamfered parallelepiped, cylinder, truncated pyramid or truncated cone.

Provision can be made for the second end face of the laser rod to have no chamfers or grooves or for said end face likewise to have at least one chamfer or groove. At least one chamfer or groove, which acts in particular as an aperture, can accordingly be provided on only one laser surface or on both. A surface situated optically opposite the light exit surface can be provided with chamfers independently of the chamfer(s) or groove(s) defining the boundary of the light exit surface. However, provision can also be made for one or a plurality of chamfers or grooves at the second end face to define a boundary of the light exit surface. One or a plurality of chamfers or grooves bounding the second end face can in particular be shaped differently than at least one chamfer or groove at the light exit surface. This can be advantageous, for example, in order to bring about a suitable asymmetrization for influencing the mode profile and/or the energy density. At least one chamfer at a surface of the laser medium situated optically opposite the light exit surface can accordingly serve as a safety chamfer, in particular for increasing the fracture toughness, but can also fulfil optical functions.

The laser medium may have a cross-sectional area which is uniform over a large part of the length of the laser medium, in particular polygonal, for example square, or round, circular, perpendicular to the longitudinal axis of the laser medium.

Accordingly, the laser medium may have over a large part of its length a cross section resulting from a parallel displacement, e.g. of a square or of a circle. The laser medium can be embodied as a parallelepiped having a square cross section which is chamfered on the side of the light exit surface. In this case, a part of the side or lateral surface is planar and can be brought into contact particularly practically with a pump light source or a heat sink.

Accordingly, the light exit surface is, in particular, smaller than a cross-sectional area perpendicular to the longitudinal axis of the laser medium.

The light exit surface can furthermore be laterally offset relative to a cross-sectional area perpendicular to the longitudinal axis of the laser medium.

In this way, by way of example, laser light can be coupled out from the laser medium depending on an asymmetrical energy density. An asymmetrical energy density in the laser medium is even a typical case since the rods are typically pumped by the side and/or lateral surface. Since the material absorbs and thus attenuates the pump light, the energy density in the rods is typically not homogenous. In most cases, the energy density is not even rotationally symmetrical or mirror-symmetrical, even if the transmitted pump light is reflected again at the opposite side, e.g. by way of a reflective coating, and for a second time is given the opportunity to be absorbed.

Accordingly, by way of an asymmetrization of the light exit surface, by way of example, provision can be made for coupling out laser light only from regions of the laser medium having (approximately) homogenous energy density.

Given homogenous energy density in the material, in the resonator, depending on the statistical number of reflections, beam profiles which are Gaussian, cylindrical or mixed forms collimated to different extents can form in the laser resonator. Specific beam profiles can be advantageous in specific applications.

Furthermore, in particular for polygonal shapes, relative to a cross-sectional area perpendicular to the longitudinal axis of the laser medium, the light exit surface can be geometrically dissimilar and/or have a different, in particular smaller, number of vertices, particularly in the case of a non-round cross section. In other words, provision can be made for the shape of the light exit surface and a cross-sectional area of the laser medium not to be convertible into one another by way of a similarity mapping. This is the case e.g. if the laser rod has a rectangular cross section and the light exit surface is square or round.

A light exit surface which is geometrically dissimilar relative to the cross-sectional area perpendicular to the longitudinal axis of the laser medium in a region which does not correspond to the light exit surface can therefore also be provided, of course, in the case of laser rods having a rotationally symmetrical cross section or laser rods having a parallelepipedal geometry.

In one embodiment of the present invention, the light exit surface is round and has a boundary which is defined by a circumferential chamfer or groove. Accordingly, a round light exit surface can be bounded in particular by a circumferential chamfer or groove. Round is understood here generally to mean that the light exit surface has no vertices.

Furthermore, the light exit surface can also be polygonal, in particular rectangular, and have boundaries which are defined by a plurality of chamfers or grooves, in particular three or four thereof. Accordingly, a polygonal, in particular rectangular, light exit surface can also be bounded by a plurality of chamfers or grooves, in particular three or four thereof. Accordingly, the light exit surface can be rectangular, in particular, the height and width of the rectangle being different.

The light exit surface can in particular be circular or elliptic and be bounded by a cone-shaped chamfer. A cone-shaped chamfer is understood to mean that the chamfer is described by a surface on a cone. In this case, the axis of the cone can extend in particular parallel to the longitudinal axis of the laser medium, in particular in the case of a circular light exit surface, or else obliquely with respect to the longitudinal axis of the laser medium, in particular in the case of an elliptic light exit surface. Accordingly, a chamfer of this type can sometimes also be referred to as a conical chamfer. The chamfer can also be described by an elliptic cone.

In one embodiment of the present invention, the light exit surface is planar and oriented in particular perpendicularly to the longitudinal axis of the laser medium and/or parallel to the second end face of the laser rod.

The laser medium or the laser rod may include a host material and, embedded therein, laser-active material for the stimulated emission of photons, wherein the host material comprises glasses or crystals (e.g. phosphate glasses, silicate glasses, YAG (yttrium aluminum garnet) or sapphire) and/or the laser-active material comprises e.g. ytterbium ions and/or erbium ions (e.g. in the glasses LG960, LG950 and LG940 produced by SCHOTT AG), neodymium ions (e.g. Nd:YAG, SCHOTT glasses APG1, APG760, LG680, LG750, LG760, LG770), titanium ions (e.g. titanium: sapphire), chromium ions and/or cobalt ions.

Suitable phosphate glasses may have a P₂O₅ content of at least 50% by weight, more preferably at least 55% by weight and/or preferably at most 85% by weight, more preferably at most 80% by weight. Furthermore, the glasses can contain Al₂O₃ preferably with a content of at least 1% by weight, more preferably at least 2% by weight and/or preferably at most 20% by weight. As further optional components, the phosphate glasses can contain fluorine (preferably from 0 to 20% by weight), one or more oxides of the alkali metals (Li, Na, K, in total preferably 0 to 20% by weight), alkaline earth metals (Mg, Ca, Ba, Sr, in total preferably 0 to 20% by weight), and oxides of the elements B, Zn, La, Gd, Nb, Y, Bi, Ge, and/or Pb. Such glasses are described for example in US 2017/0217828, U.S. Pat. Nos. 5,526,369, 5,032,315, 5,173,456 and 4,929,387, the disclosure of which should be deemed to be incorporated within the full scope thereof in this description.

While phosphate glasses exhibit outstanding optical properties for use as active laser material, for example on account of their excellent pump and emission properties, thermal and mechanical parameters have highly disadvantageous values. In this regard, both the thermal conduction and the fracture toughness of a laser crystal, such as e.g. Nd:YAG, are each more than one order of magnitude better than those of phosphate glasses, the coefficient of thermal expansion on average being approximately one third lower than that of phosphate glasses, and Young's modulus being greater on average by a factor of 5-6. As a consequence, during laser operation of phosphate glasses, given the same geometry, significantly stronger temperature profiles and thus thermal lenses form, and material fracture on account of temperature gradients or thermal shock is much more likely. It is therefore necessary to reduce as much as possible the size of the active laser glass components and the heat conducting path from the usable volume to the externally fitted heat sink.

Besides the disadvantages of the thermal and mechanical properties, phosphate glasses also appear to be unsuitable as host material since they are furthermore hygroscopic and water-soluble. Moreover, they are highly fragile and scratchable and have a soft surface.

It has been found that with phosphate glasses as host material, not only is it possible to realize very small dimensions of the laser rod, but in specific applications it is even necessary for thermal reasons to reduce the size of the laser rods as much as possible. In the case of cylindrical laser rods, the diameters can be less than 6 mm, preferably less than 5 mm and particularly preferably less than 4 mm, less than 3 mm and even less than 2 mm. It is even possible to produce laser rods having a diameter of, for example, 1.5, 1.2, 1.0 or 0.9 mm from phosphate glass. In particular, the phosphate glasses LG960, LG950 and LG940 doped with laser-active materials can be used for this purpose. The abovementioned dimensions of the laser rod also apply, of course, to other, similar geometries, that is to say for example laser rods having a polygonal cross section.

Since phosphate glasses and in particular the surface of components composed of phosphate glass are very sensitive to water and smaller components have a larger surface area relative to the total volume, it was assumed that very small laser rods composed of phosphate glass are impracticable. It has been found that, by way of rapid installation into a corresponding housing encapsulation with few handling processes and few additional individual components, it is possible to produce and maintain the quality of the laser rod. Apertures which in the case of laser rods having the dimensions described are advantageously intended to improve the beam properties must then have a specific minimum geometric accuracy as far as shape, cross-sectional size and positioning are concerned. If the aperture is intended to have an effect in the case of rods of the described size by way of a chamfer or groove, then it is advantageous if the chamfer or the groove has a size and positional accuracy of at least 0.1 mm, preferably at least 0.05 mm, particularly preferably at least 0.02 mm and very particularly preferably at least 0.01 mm.

In this case, it was not evident that it should be assumed that it may be possible at all, on components composed of such soft, water-soluble, hygroscopic material having polished or even antireflection-coated surfaces, even in the case of these very small dimensions of the laser rod, still to produce the chamfer or groove according to the invention with the necessary precision.

Generally and without restriction to the embodiments of the present invention mentioned above, however, the laser-active material can include ytterbium ions, erbium ions, neodymium ions, praseodymium ions, samarium ions, europium ions, gadolinium ions, terbium ions, dysprosium ions, holmium ions, thulium ions, cerium ions, chromium ions, cobalt ions, vanadium ions, nickel ions, molybdenum ions and/or titanium ions.

Erbium-ion-based solid-state media may be advantageous in particular for producing so-called “eye-safe” laser media. The latter are used in the medical and military fields, for example. The optically active ions can accordingly be erbium ions (Er′), which are embedded e.g. in phosphate glass and lase at approximately 1535 to 1550 nm. Pumping can be effected indirectly by way of ytterbium (Yb³⁺, diode-pumped, around 950 nm) or by way of chromium (Cr³⁺) and ytterbium (flashlamp-pumped, visible and near infrared spectrum).

Preferably, the concentration of the ytterbium ions is in the range of 5×10²⁰ cm⁻³ to 30×10²⁰ cm⁻³, that of the erbium ions is in the range of 0.1×10²⁰ cm⁻³ to 2×10²⁰ cm⁻³, that of the chromium ions is in the range of 0.01×10²⁰ cm⁻³ to 0.2×10²⁰ cm⁻³ and/or that of the neodymium ions is in the range of 0.1×10²⁰ cm⁻³ to 10×10²⁰ cm⁻³.

Consequently, e.g. ion concentrations (dopings) can be provided as follows:
Diode-pumped: Yb³⁺: 15*10²⁰ cm⁻³
   Er³⁺: 0.5*10²⁰ cm⁻³
or: Yb³⁺: 20*10²⁰ cm⁻³
   Er³⁺: 0.2*10²⁰ cm⁻³
Flashlamp-pumped: Yb³⁺: 23*10²⁰ cm⁻³
   Er³⁺: 0.2*10²⁰ cm⁻³
   Cr³⁺: 0.05*10²⁰ cm⁻³

In one embodiment of the present invention, the laser medium can comprise a partly reflective coating applied on the light exit surface, in particular on the first end face.

Accordingly, a partly reflective coating on the light exit surface can function as an output coupling mirror of a resonator. In this way, besides the aperture stop, a further component for a laser system can be saved, with the result that the costs can be reduced and assembly can be facilitated.

On the other hand, provision can also be made of a highly reflective coating (i.e. almost 100% reflectivity) applied on an end face, on the lateral surface and/or on the at least one chamfer or groove (i.e. on the chamfer or groove surface(s)). A highly reflective coating applied on a surface of the laser medium situated opposite the light exit surface can serve in particular as an end mirror of a resonator. This, too, makes it possible to save a component and hence costs.

Coatings on the laser medium can be applied in particular by way of an atomic layer deposition method. Consequently, provision can also be made for laser rods, in particular small laser rods, to be completely encapsulated, wherein optionally an opening for pump light can be provided.

The laser medium furthermore includes at least one pump light surface for coupling in pump light. A laser rod can be pumped e.g. through the side and/or lateral surface. In other words, at least one side surface of the laser medium can be embodied as a pump light surface. In this case, provision can be made for pumping to be effected only from one direction, i.e. from one side surface, wherein a reflective coating, in particular a highly reflective coating, can be applied on the side surface situated opposite the pump light surface, the coating reflecting the pump light back into the interior of the rod. A more efficient energy yield of the pumping can be ensured as a result.

In this case, provision can be made for the transition from the light exit surface to the at least one side surface embodied as pump light surface to be formed by only one edge, wherein the transition angle is preferably 90 degrees. In other words, depending on laser geometry and properties, it can be advantageous for the aperture-delimiting chamfers or grooves to be provided only at the side surfaces (or the edges thereof with the light exit surface) through which pumping is not effected, while the pump side surface has no chamfer. The inversion concentration and thus the energy density are the highest directly at this side surface, and so there would be a desire for this volume region of the active laser medium to be completely utilized.

The pump light surface can e.g. also be formed only by a partial surface of a side surface. By way of example, provision can be made of an opening within a reflective coating, in particular a highly reflective coating, which forms the pump light surface. Such an opening can be embodied e.g. as a slit opening. Together with a reflective coating situated opposite, the pumping efficiency can once again be increased. In addition, heating of other components of the laser system can be reduced. It is also possible for all the side surfaces to be provided with such a reflective coating and for only a slit opening to be left open for pumping.

The reflective coatings, i.e. the coating, can be e.g. a dielectric multilayer system, or else a metal coating which reflects in the corresponding spectral range, e.g. a coating with gold, copper, silver or aluminum.

In one embodiment of the present invention, the laser medium has a length along the longitudinal axis of at least 1 millimeter, preferably at least 5 millimeters, and/or at most 1000 millimeters, preferably at most 500 millimeters, in accordance with specific embodiments preferably at most 50 millimeters. The laser medium furthermore preferably has a cross-sectional area perpendicular to the longitudinal axis of at least 0.25 mm² and at most 10 000 mm², preferably at most 1000 mm², in accordance with specific embodiments preferably at most 100 mm².

In this regard, by way of example, provision can indeed be made of laser rods having diameters of up to 100 mm and lengths of up to 700 mm.

The geometries of the laser rods can be for example:
square cross section with 1.5×1.5×20 millimeters,
rectangular cross section with 2×5×10 millimeters,
round cross section with Ø1.8×25 millimeters,
   wherein the rods each have at least one chamfer, which can serve not only as an aperture stop but also for reducing the risk of fracture. A round rod can have a round chamfer, for example, which increases the fracture toughness. Moreover, the risk of spawling at the edge, which can potentially even scratch the surface, is reduced as a result.

For rotationally symmetrical laser rods as laser medium, the embodiments designated as variants 1 and 2 in table 1 below arise, for example, which embodiments list possible dimensions. Further, possible dimensions are indicated by the preferred sizes 1, 2 and 3. Two possible sizes for the laser rods according to the invention are indicated by the designation example 1 and example 2. These rotationally symmetrical laser rods in accordance with table 1, that is to say in accordance with variant 1 or 2, size 1, 2 or 3, or in accordance with example 1 or 2, may include the phosphate glasses mentioned further above, in particular the glasses LG960, LG950 and LG940 produced by SCHOTT AG.

TABLE 1
Possible dimensions for laser rods having a rotationally
symmetrical cross section

| | | | | | Surface |
|---|---|---|---|---|---|
| | Cylinder | Cylinder | Surface | | area |
| | diameter | height | area | Volume | per volume |
| | [mm] | [mm] | [mm²] | [mm³] | [mm⁻¹] |
| Variant 1 | 4 | 60 | 779.1 | 754.0 | 1.0 |
| Variant 2 | 2.5 | 30 | 245.4 | 147.3 | 1.7 |
| Size 1 | 1.8 | 25 | 146.5 | 63.6 | 2.3 |
| Size 2 | 1.5 | 20 | 97.8 | 35.3 | 2.8 |
| Size 3 | 1.2 | 11 | 43.7 | 12.4 | 3.5 |
| Example 1 | 1 | 10 | 33.0 | 7.9 | 4.2 |
| Example 2 | 0.7 | 5 | 11.8 | 1.9 | 6.1 |

For parallelepipedal laser rods as laser medium, the embodiments designated as variants 1 and 2 in table 2 below arise, for example, which embodiments list possible dimensions. Further, possible dimensions are indicated by the preferred sizes 1, 2 and 3. Two possible sizes for the laser rods according to the invention are indicated by the designation example 1 and example 2. These parallelepipedal laser rods in accordance with table 2, that is to say in accordance with variant 1 or 2, size 1, 2 or 3, or in accordance with example 1 or 2, may include the phosphate glasses mentioned further above, in particular the glasses LG960, LG950 and LG940 produced by SCHOTT AG.

TABLE 2
Possible dimensions for laser rods having a parallelepipedal geometry

| | | | | | | Surface |
|---|---|---|---|---|---|---|
| | Parallelepiped | Parallelepiped | Parallelepiped | Surface | | area per |
| | length | width | height | area | Volume | volume |
| | [mm] | [mm] | [mm²] | [mm²] | [mm³] | [mm⁻¹] |
| Variant | 30 | 5 | 5 | 650.0 | 750.0 | 0.9 |
| 1 | | | | | | |
| Variant | 10 | 6 | 1.3 | 161.6 | 78.0 | 2.1 |
| 2 | | | | | | |
| Size 1 | 25 | 4 | 4 | 432.0 | 400.0 | 1.1 |
| Size 2 | 20 | 1.5 | 1.5 | 124.5 | 45.0 | 2.8 |
| Size 3 | 10 | 6 | 1.2 | 158.4 | 72.0 | 2.2 |
| Example | 4 | 2 | 1 | 28.0 | 8.0 | 3.5 |
| 1 | | | | | | |
| Example | 3 | 0.7 | 0.7 | 9.4 | 1.5 | 6.4 |
| 2 | | | | | | |

The ratio of surface area to volume (A/V ratio) plays a central part for the present invention since, on the one hand, a small volume of the laser medium should be rated positively, in principle, because it can be introduced for instance comparatively simply into a corresponding heat sink and heat can be dissipated from the pumped volume. On the other hand, however, a certain length is also required in order to be able to optimally utilize the desired optical properties of the laser medium in conjunction with the laser beam.

The value for the A/V ratio is therefore at least 0.8, preferably at least 1 and particularly preferably at least 2. At the same time, the A/V ratio should not be greater than 10, preferably not greater than 8 and particularly preferably not greater than 7. Accordingly, for a laser medium according to the invention comprising a phosphate glass as host material, the ratio of surface area to volume of the laser medium is in a range of between 0.8 and 10, preferably between 1 and 8 and particularly preferably between 2 and 7.

In the case of such small components, the adjustment and alignment of additional stop components is very complex, and so the boundary according to the invention of the light exit surface with at least one chamfer or groove has a very advantageous effect.

The present invention furthermore relates to a laser device comprising a laser medium according to the invention, a pump source for introducing pump light into the laser medium, and a resonator for multiple reflection of photons, wherein the resonator comprises an output coupling mirror formed in particular by a partly reflective coating, or an end mirror formed in particular by a highly reflective coating. A partly and respectively highly reflective coating can also be referred to as reflective coating. In this case, provision can be made for chamfers or grooves which define a boundary of the light exit surface of the laser medium, i.e. aperture-imparting chamfers or grooves, to be on the reflectively coated side, the non-reflectively coated side or both sides.

Finally, the present invention relates to a method for producing a laser medium, wherein
a laser medium having a light exit surface and at least one edge which forms a transition between the light exit surface and a lateral surface of the laser medium is provided, and
the at least one edge is chamfered, in particular by grinding away, polishing away and/or milling away the edge.

The term chamfering is understood to mean, in particular, that an edge is processed in such a way that two edges arise; accordingly, the intention is also for the provision of a hollow channel or a rounded portion, etc. not to be excluded. Such chamfering can be carried out e.g. manually or else by way of a CNC machine. Furthermore, the provision of more than two edges can also be provided, in particular by way of folding or slotting, etc.

In the case of the very small and soft components according to the invention, for this purpose it is possible to have recourse to grinding or polishing processes which, on account of polishing grit material and size, are not very abrasive and remove material only very slowly. Typically, glass is polished by employing polishing grit materials composed of cerium oxide since these bond well to the glass and achieve a high rate of removal as a result. This is not desired when providing the chamfer or groove. Therefore, polishing grit materials which form not as strong covalent bonds with the laser material, such as e.g. Al₂O₃, SiO₂, or diamond, are better suited to the method for producing the laser medium. In order to achieve a good precision, in this case, the surface roughness of the ground chamfer or groove must also not be too high and, consequently, the grains of polishing grit must not be too large either. The latter may advantageously correspond to the quality of 400 grit or better. In this case, it is possible to employ unbonded grit (“slurries”) or bonded grit. Furthermore, it may be advantageous when removing very small amounts of material with the process not to aim to be at the center of the size or position specification. Rather, success is more likely if the amount of material removed is only such that the process is implemented near the upper tolerance limit and, in this way, if appropriate, further material can be removed. If such a material removal process is actually implemented below the lower tolerance limit, then the component is no longer in conformity because material cannot be added again afterward. Furthermore, it may be advantageous to employ a plurality of iterations of a removal and measurement feedback loop, particularly in the case of extremely tightly specified sizes of the chamfer. The chamfer or groove size can be measured using a measuring microscope. In this way, on laser rods having a diameter of less than 2 mm, it is possible to provide chamfers with a size accuracy of less than 10 micrometers, even if said laser rods consist of soft, water-sensitive phosphate glasses or comprise phosphate glasses of this type.

In one embodiment, a laser rod having a rectangular cross section is optically pumped through a side surface. Since the pumping is effected by absorption, the intensity of the pump light decreases approximately exponentially with the distance from the surface through which pumping is effected. As a result, the highest energy density arises directly at the corresponding side surface. In this case, it would be disadvantageous, by virtue of a chamfer at the edge which forms the laser exit or entrance surface with the pump surface, to trim the laser beam by way of a chamfer. In order then to form the aperture in an advantageous manner, the chamfer is arranged at the or one of the other three edges of the laser exit or entrance surface and the edge at the pump surface remains without a chamfer.

In a similar embodiment and for a similar reason, round or rectangular apertures bounded by chamfers can be arranged asymmetrically and be situated nearer to the side of the laser rod through which pumping is effected.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1a-1b show laser devices having a laser rod, a pump source and a resonator;

FIGS. 2a-2c show a square laser rod having a centrally positioned rectangular aperture and chamfers of 45 degrees;

FIGS. 3a-3c show a square laser rod having a centrally positioned rectangular aperture and chamfers of different angles;

FIGS. 4a-4c show a square laser rod having a centrally positioned round aperture and a cone-shaped chamfer, wherein the axes of symmetry of the laser rod and of the chamfer are identical;

FIGS. 5a-5c show a square laser rod having a round aperture positioned in a manner displaced relative to the center, and having a cone-shaped chamfer, wherein the axes of symmetry of the laser rod and of the chamfer are parallel;

FIGS. 6a-6c show a square laser rod having an elliptic aperture and a cone-shaped chamfer, wherein the axes of symmetry of the laser rod and of the chamfer extend obliquely with respect to one another;

FIGS. 7a-7c show a square laser rod having a centrally positioned elliptic aperture and a chamfer of 45 degrees;

FIGS. 8a-8b show a square laser rod having a centrally positioned round aperture and a groove (step) embodied as a fold, wherein the axes of symmetry of the laser rod and of the step are identical;

FIGS. 9a-9b show a round laser rod having a centrally positioned round aperture and a stepped groove (fold), wherein the axes of symmetry of the laser rod and of the fold are identical;

FIGS. 10a-10b show a round laser rod having a round aperture arranged in a non-centered manner, and having a stepped groove (fold), wherein the axes of symmetry of rod and fold are parallel;

FIGS. 11a-11b show a round laser rod having a centrally positioned round aperture and a stepped groove (fold), wherein the axes of symmetry of rod and fold are identical and wherein edges adjoining the lateral surface are additionally provided with a safety chamfer;

FIGS. 12a-12b show a round laser rod having a centrally positioned round aperture and a stepped groove (fold), wherein the axes of symmetry of rod and fold are identical and wherein all edges are additionally provided with a safety chamfer embodied as a rounded portion;

FIGS. 13a-13b show a round laser rod having a centrally positioned octagonal aperture;

FIGS. 14a-14b show a round laser rod having a centrally positioned round aperture and a slitted groove (round slot), wherein the axes of symmetry of rod and slot are identical;

FIGS. 15a-15b show a round laser rod having a centrally positioned round aperture and a slitted groove (round slot), wherein the axes of symmetry of rod and slot are identical and wherein additional (non-aperture-effective) safety chamfers are provided;

FIGS. 16a-16c show a parallelepipedal laser rod having a rectangular aperture and chamfers at three of the four sides of the light exit surface, such that the latter directly adjoins one of the side surfaces;

FIGS. 17a-17c show a parallelepipedal laser rod having a rectangular aperture and chamfers at three of the four sides of the light exit surface, such that the latter directly adjoins one of the side surfaces and wherein this side surface is a pump light surface and the other side surfaces are reflectively coated;

FIGS. 18a-18c show a laser rod having a round aperture positioned in a manner displaced relative to the center, and having a cone-shaped chamfer, wherein the axes of symmetry of rod and chamfer are parallel and wherein the aperture is displaced toward a longitudinal edge (edge parallel to the longitudinal axis of the laser medium) and wherein a pump light entrance surface is polished at said longitudinal edge and wherein the four side surfaces are coated with a mirror layer that is reflective for pump light;

FIGS. 19a-19b show a square laser rod having a centrally positioned rectangular aperture and chamfers of different angles, wherein (a) the chamfered side of the laser rod is (partly) reflectively coated and the other side of the laser rod is antireflection-coated, or (b) the chamfered side of the laser rod is antireflection-coated and the other side of the laser rod is (partly) reflectively coated; and

FIGS. 20a-20c show a square laser rod having a centrally positioned rectangular aperture and two pairs of chamfers on opposite sides of the laser rod, wherein chamfers of 45 degrees are involved.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

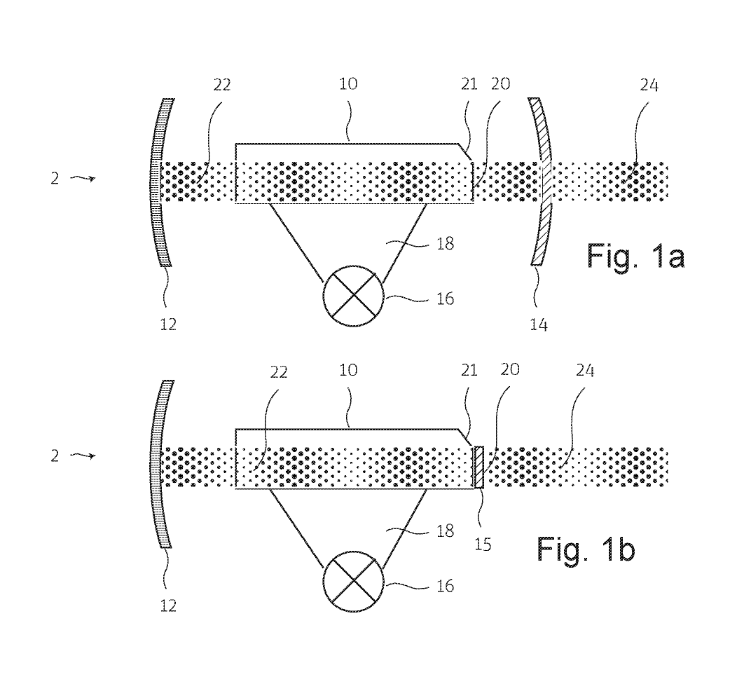

Referring to FIG. 1a, an exemplary and greatly simplified laser device 2 includes a laser medium 10, a resonator having an end mirror 12 and an opposite output coupling mirror 14, and also a pump light source 16 for generating pump light 18. The pump light 18 can generate population inversion in the laser medium 10.

In many laser systems there are further elements within the cavity, such as e.g. saturable absorbers as a Q-switch (e.g. composed of cobalt spinell) in pulsed laser systems.

In the likewise greatly simplified example shown in FIG. 1b, the laser medium 10 is provided with a coating 15, wherein the coating 15 is a partly reflective coating in order to enable light to be coupled out. The partly reflective coating and the end mirror 12 serve as a resonator. As is evident to the person skilled in the art, conversely, a highly reflective coating together with an end mirror can also serve as a resonator.

With regard to both examples in FIGS. 1a and 1b, laser modes 22 can build up oscillations along the optical axis as a result of induced emission of photons by laser-active material in the laser medium and with the support of multiple reflection of photons in the resonator.

In the examples shown, the laser medium 10 has a chamfer 21. The latter can prevent e.g. (as illustrated) laser modes from forming parallel to the optical axis even where the chamfer 21 is situated. On the other hand the chamfer 21 can influence the mode profile and/or the energy density in the laser medium 10, in particular in transverse or oblique directions, in a targeted manner (not shown here).

The chamfer 21 furthermore serves in particular as an aperture stop, in such a way that a spatial selection of laser light is effected, in particular in a plane perpendicular to the optical axis. The chamfer 21 accordingly defines the light exit surface 20, which serves as an aperture and through which photons can leave the laser medium. A laser beam 24 shaped by the chamfer 21 is thus generated.

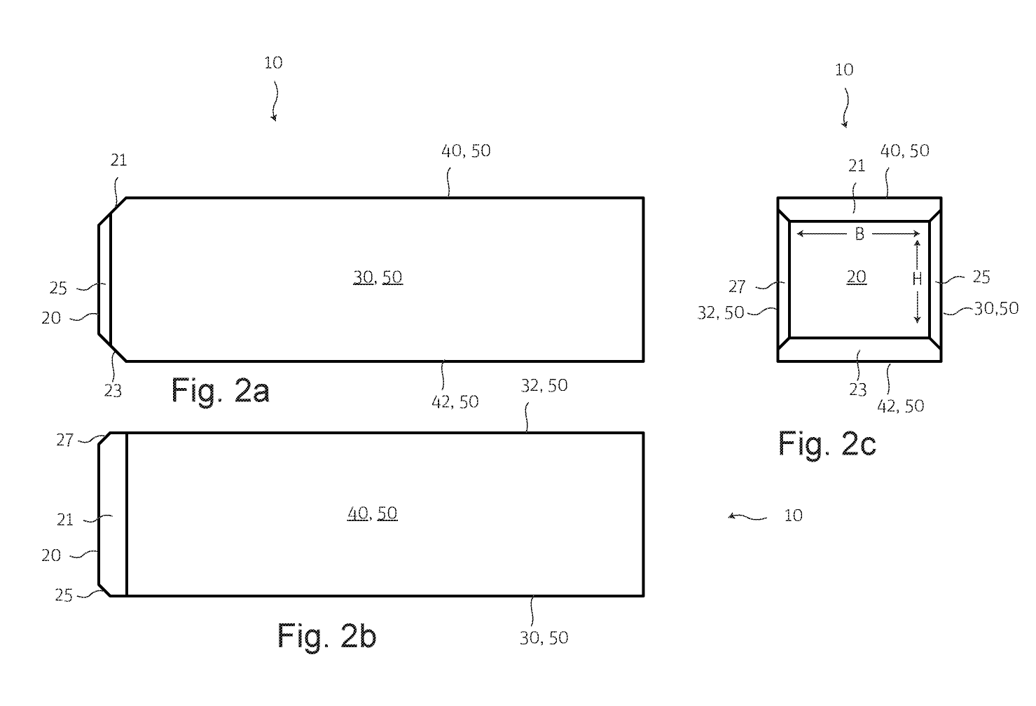

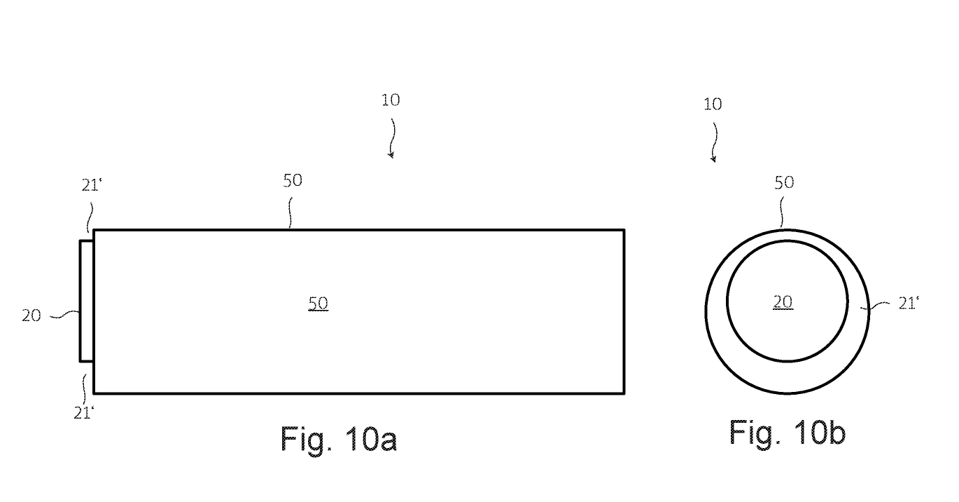

FIGS. 2 to 20 describe some possible embodiments of laser media having at least one chamfer or groove. The embodiments shown should be understood not to be exhaustive.

FIGS. 2a-2c show a laser medium 10 embodied as a laser rod in a side view (FIG. 2a), a plan view (FIG. 2b) and in a front view of the light exit surface 20 (FIG. 2c).

The laser medium 10 has a rectangular, here square, cross section, as can be seen in FIG. 2c. The light exit surface 20 is bounded on all sides by chamfers 21, 23, 25, 27, which taken together act as an aperture stop.

The chamfers each form transitions to the lateral surface 50 of the laser medium: the chamfer 27 forms a transition to the side surface 32 of the lateral surface 50 and the chamfer 25 forms a transition to the side surface 30 of the lateral surface 50, as can also be seen in the side view in FIG. 2a. Analogously, the chamfer 23 forms a transition to the side surface 42 of the lateral surface 50 and the chamfer 21 forms a transition to the side surface 40 of the lateral surface 50, as can also be seen in the plan view in FIG. 2b.

As shown, the light exit surface 20 acting as an aperture is embodied in a rectangular fashion, wherein the width B and the height H have different lengths. The cross section of the laser medium 10, which is square here, is accordingly not geometrically similar to the light exit surface.

The light exit surface 20 may be arranged in a centered manner with respect to the longitudinal axis of the laser medium 10. In other words, the midpoint of the light exit surface 20 lies on the optical axis. To put it another way, there is no lateral offset of the light exit surface 20.

The angles between the light exit surface 20 and the chamfer surfaces 21, 23, 25, 27 can be identical, in particular obtuse, angles; here they are in each case 135 degrees. The supplementary angle associated with 135 degrees to form 180 degrees is 45 degrees; therefore, reference is also made to a chamfer at 45 degrees. The angles between the chamfer surfaces 21, 23, 25, 27 and the adjoining side surfaces 40, 42, 30, 32 are also in each case identical angles of 135 degrees here.

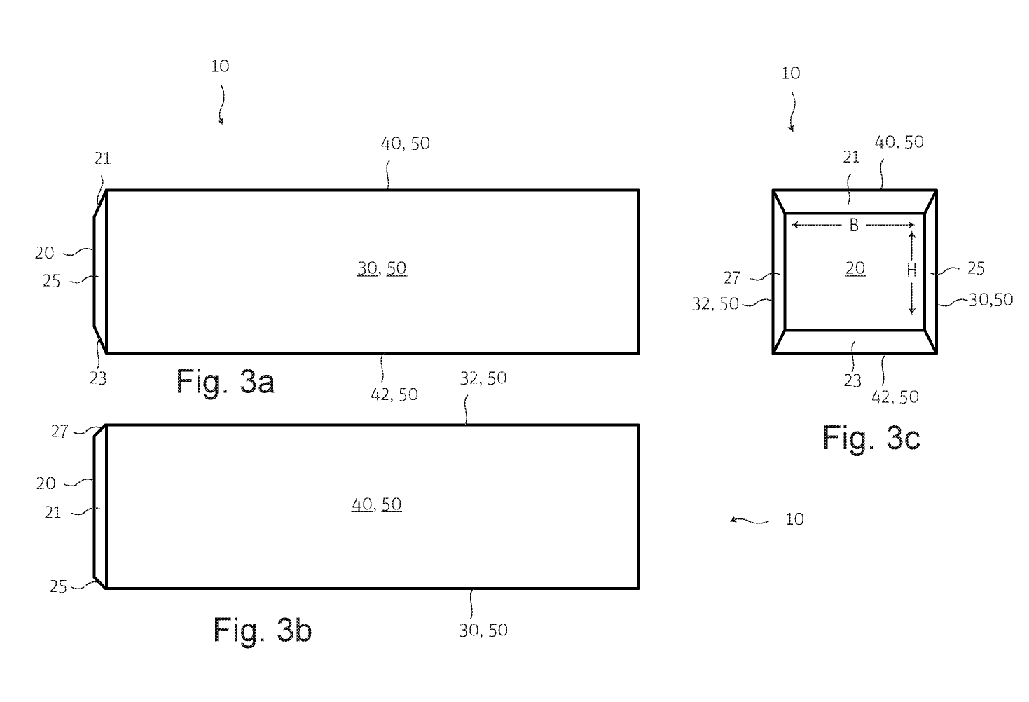

Referring to FIGS. 3a-3c, as also in FIGS. 2a-2c, all angles between chamfer surfaces and light exit surface and between chamfer surfaces and lateral surface are obtuse angles. The laser rod once again has a square cross section and a centered, rectangular aperture.

By comparison with the example in FIGS. 2a-2c, however, the angles between the light exit surface 20 and the chamfer surfaces 21, 23, 25, 27 are not identical. The angles between the chamfer surfaces 21, 23, 25, 27 and the lateral surface 50 are not identical either. The chamfers thus have different inclination angles.

Generally, without restriction to this example, one or a plurality of chamfers can have different angles in different directions. Owing to the different angles here (by comparison with the laser medium 10 in FIGS. 2a-2c), the chamfering of the laser medium 10 in the direction of its longitudinal axis is identical for the chamfers 21, 23, 25, 27 bounding the light exit surface.

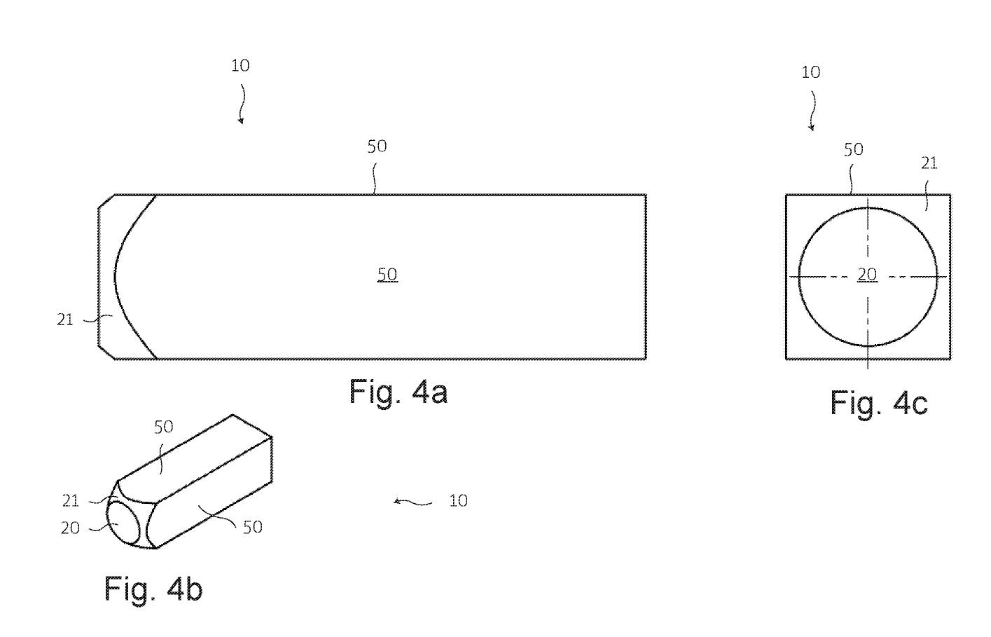

Referring to FIGS. 4a-4c to 7a-7c, laser media having a non-round cross section (e.g. having a rectangular or square cross section) can have e.g. a round or elliptic light exit surface 20 (aperture). In this case, the chamfer surface can be described for example by a partial surface of a cone surface. This is also referred to as a cone-shaped chamfer.

FIGS. 4a-4c show a laser medium 10 embodied as a laser rod in a side view (FIG. 4a), a perspective view (FIG. 4b) and in a front view of the light exit surface 20 (FIG. 4c).

The laser rod has an angular, here square, cross section and a round, here circular, light exit surface 20. In this example, the light exit surface 20 is centered with respect to the axis of symmetry of the rod.

The chamfer 21 can be designated as a cone-shaped chamfer, in this example also as a conical chamfer, since the chamfer surface can be described by a surface on a right circular cone. The axis of symmetry of this circular cone is identical here to the longitudinal axis of the laser medium 10. In other words, the axis of symmetry of the chamfer or of the chamfer surface is identical to the axis of symmetry of the rod.

The opening angle of the cone here is 90 degrees. This gives rise to a chamfer of 45 degrees. Generally, the cone can have virtually any desired opening angles required to obtain the desired chamfer angles.

In the example in FIGS. 4a-4c, the diameter of the light exit surface (aperture) is approximately 80% of the side edge. Without restriction to this example, the light exit surface can have in particular between 10 and 99%, preferably between 20 and 95%, particularly preferably between 30 and 90%, of a cross-sectional area of the laser medium 10 perpendicular to the longitudinal axis thereof.

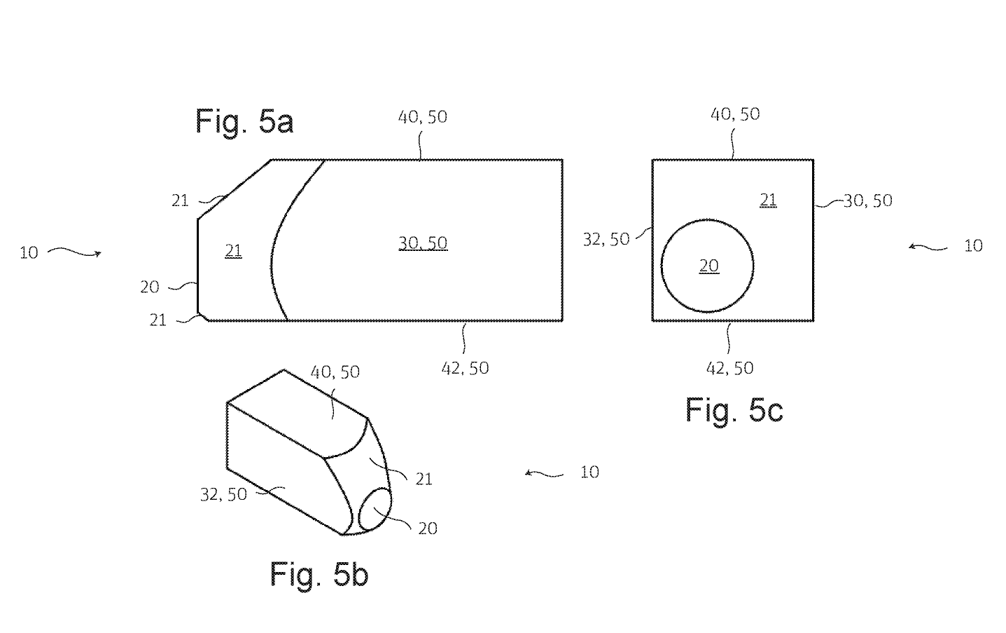

Referring to FIGS. 5a-5c, the axis of symmetry of a (circular) cone describing the chamfer surface 21 can be offset relative to the axis of symmetry (longitudinal axis) of the rod but e.g. parallel thereto. In other words, the axis of symmetry of a chamfer, with respect to the optical axis of the rod, can be displaced identically or at a different extent in one or both directions transversely with respect to the longitudinal axis of the rod, such that the light exit surface 20 (aperture) is not centered.

This embodiment is of interest particularly if energy is not pumped into the laser medium from all side surfaces 30, 40, 32, 42 equally with pump light and the laser beam does not form in the center of the laser rod on account of the energy density distribution. The asymmetrical shape of the laser medium 10 shown in FIG. 5 can accordingly be adapted to an asymmetrical energy density in the laser medium. The parameters for such an adaptation can e.g. also be refined by way of computer simulations.

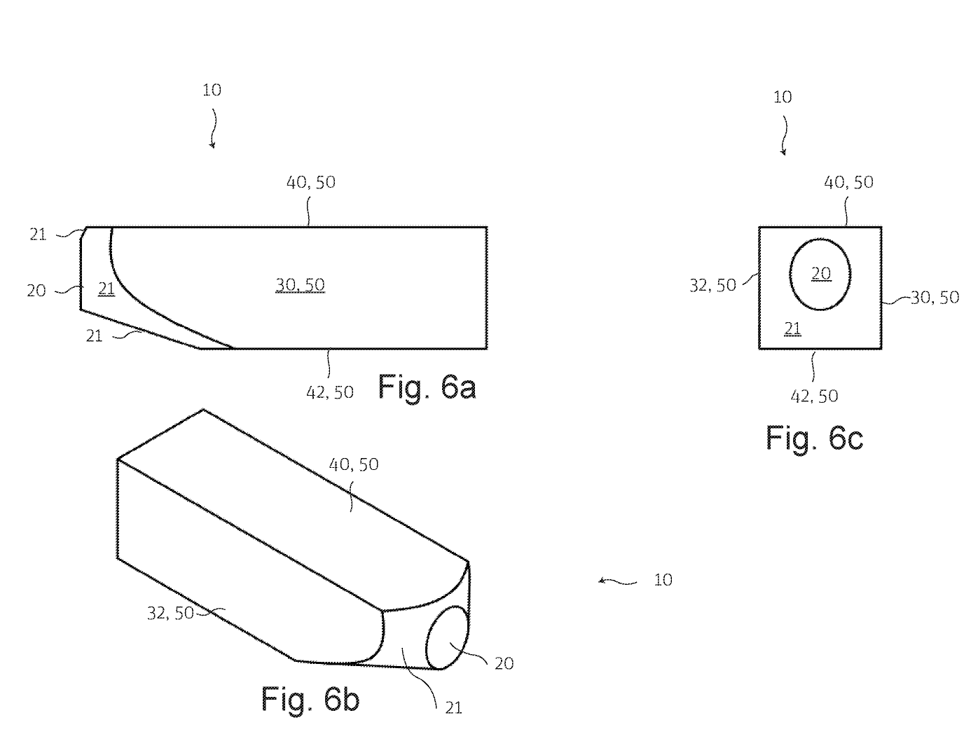

Referring to FIGS. 6a-6c, the axis of symmetry of a (circular) cone describing the chamfer surface 21 can extend obliquely relative to the longitudinal axis of the laser medium 10. In accordance with the theory of conic sections, in particular an elliptic light exit surface 20 can thus be obtained. This is the case particularly if the light exit surface 20 is oriented perpendicularly to the longitudinal axis of the rod.

In other words, the axis of symmetry of the cone-shaped chamfer can be at an angle with respect to the optical axis of the laser medium 10 which is different than zero.

By virtue of elliptic apertures (light exit surfaces 20), breaks of rotational symmetries on account of asymmetrical geometry of the rod (e.g. rectangular) or on account of pumping can be compensated for in a particularly advantageous manner.

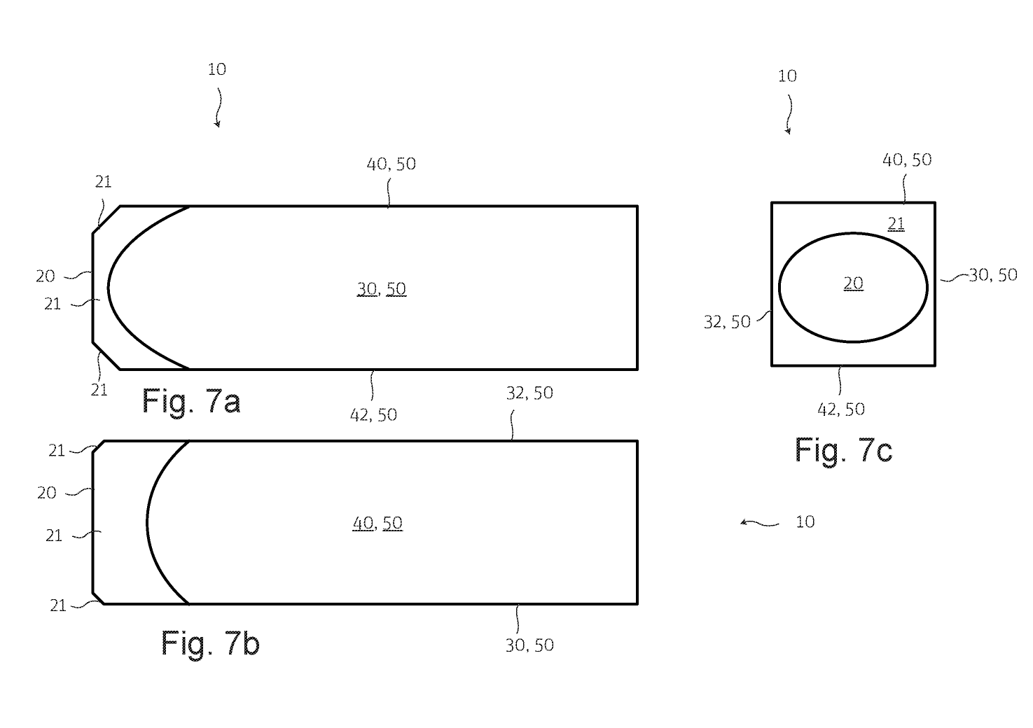

FIGS. 7a-7c show a laser medium 10 embodied as a laser rod in a side view (FIG. 7a), a plan view (FIG. 7b) and in a front view of the light exit surface 20 (FIG. 7c). The laser medium has an elliptic light exit surface 20 with the same chamfer angle (here 45 degrees) all around.

An elliptic aperture can accordingly be achieved even if the chamfer always has the same angle. The chamfer surface can accordingly also have two axes of symmetry.

Furthermore, the chamfer can have different angles in different directions, particularly in the case of an elliptic cone describing the chamfer surface.

The conic section having the first end face of the laser medium 10 then yields an ellipse corresponding to the light exit surface 20. This holds true, moreover, even if the axis of symmetry of the cone extends parallel to the optical axis of the rod.

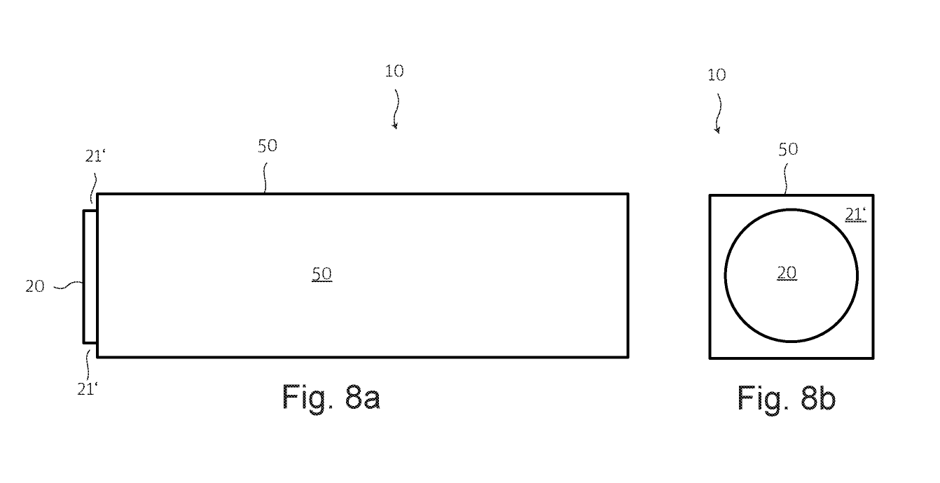

Referring to FIGS. 8a-8b to 12a-12b, the laser medium 10 can have at least one marginal groove 21′, in other words a step or a rabbet. Just like a chamfer, the groove 21′ can prevent the formation of laser modes parallel to the optical axis in the region of the groove 21′. Accordingly (just like a chamfer) the groove 21′ defines the boundary of the aperture, that is to say serves in particular as an aperture stop.

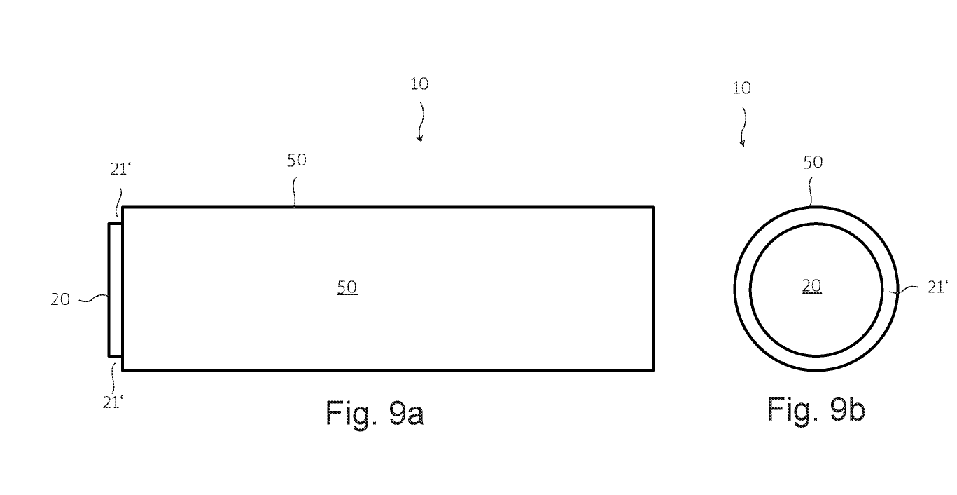

FIGS. 8a-8b to 12a-12c show a laser medium 10 embodied as a laser rod in a side view (FIGS. 8a to 12a) and in a front view of the light exit surface 20 (FIGS. 8b to 12b). The laser rod shown in FIG. 8 has a square cross-sectional area, while the laser rods shown in FIGS. 9a-9b to 12a-12b have a round, more precisely circular, cross-sectional area.

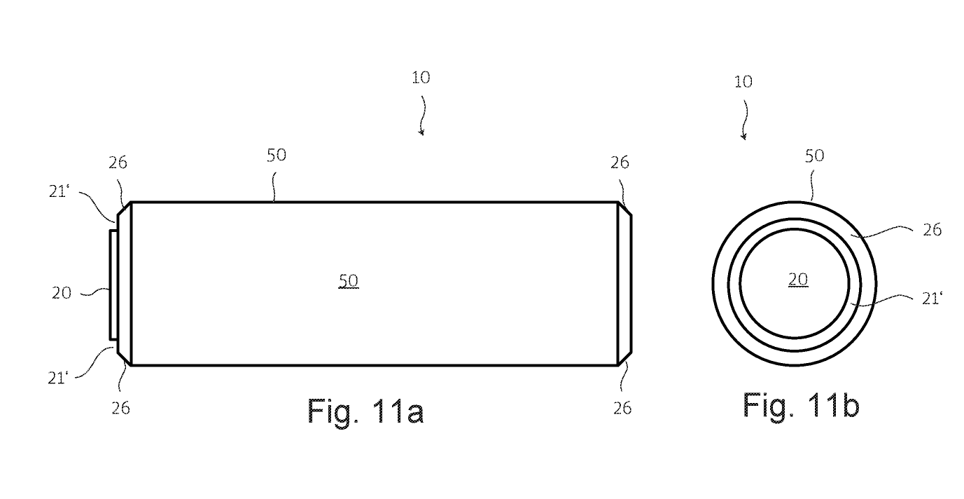

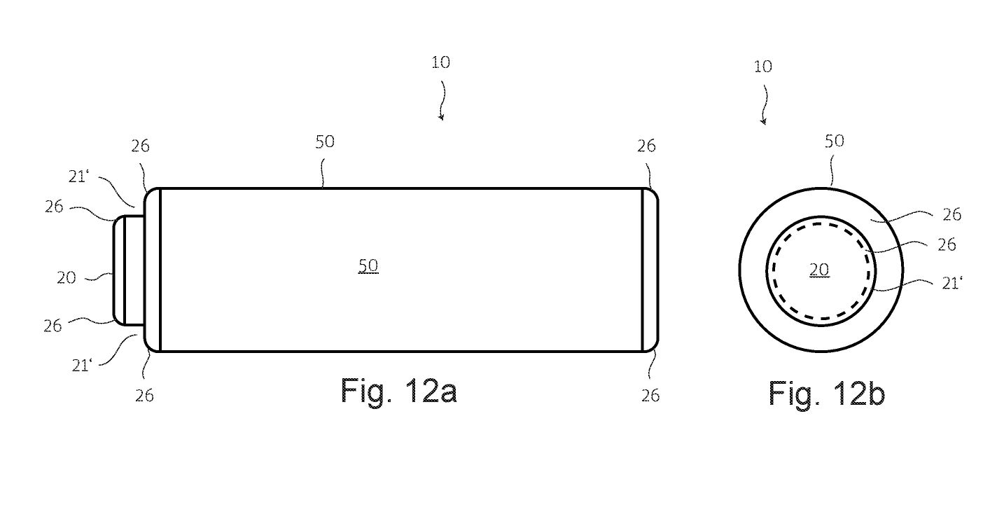

Referring to FIGS. 11a-11b and 12a-12b, particularly in the case of a groove 21′ which defines a boundary for a light exit surface 20, provision can be made for one or more edges of the groove to be chamfered, i.e. provided with a chamfer 26, wherein the term chamfer is intended also not to exclude a rounded portion or a hollow channel, etc. The chamfer 26 can be embodied in particular as a safety chamfer, i.e. can increase the fracture toughness of the laser rod at the respective edge. In other words, a chamfer 26 can be provided at an edge, in particular at an edge of a groove 21′, in order to increase the fracture toughness of the laser medium.

Referring to FIGS. 11a-11b, such a chamfer 26 embodied as a safety chamfer need not be defining for the boundary of the light exit surface. However, a safety chamfer can also be aperture-effective: in FIGS. 12a-12b, the boundary of the light exit surface 20 is defined e.g. by the dashed line. Furthermore, a safety chamfer can also affect the mode profile.

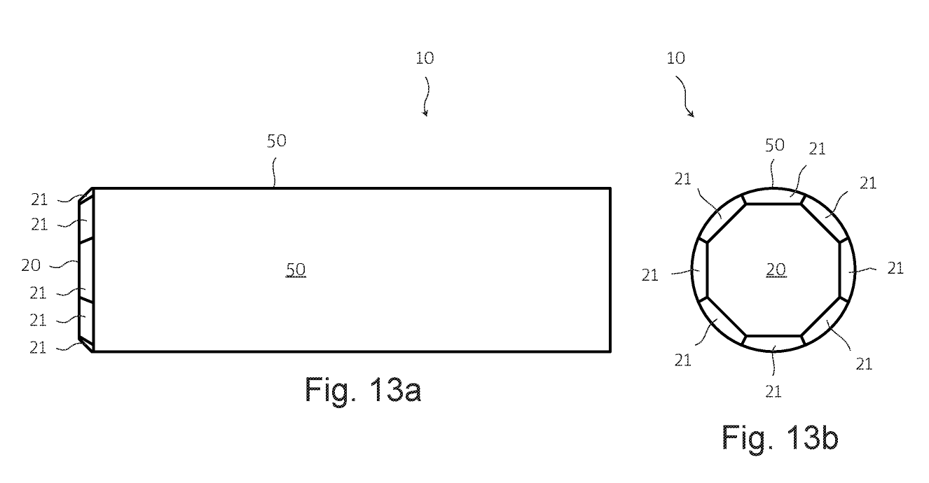

The laser medium 10 illustrated in FIGS. 13a-13b has a polygonal light exit surface 20, which has a boundary on all sides which is defined by a plurality of chamfers 21 adjoining the light exit surface 20. The boundary on all sides, i.e. the closed edge, of the light exit surface 20 comprises a plurality of straight boundaries, here eight edge sections, such that the light exit surface 20 is embodied as an octagon.

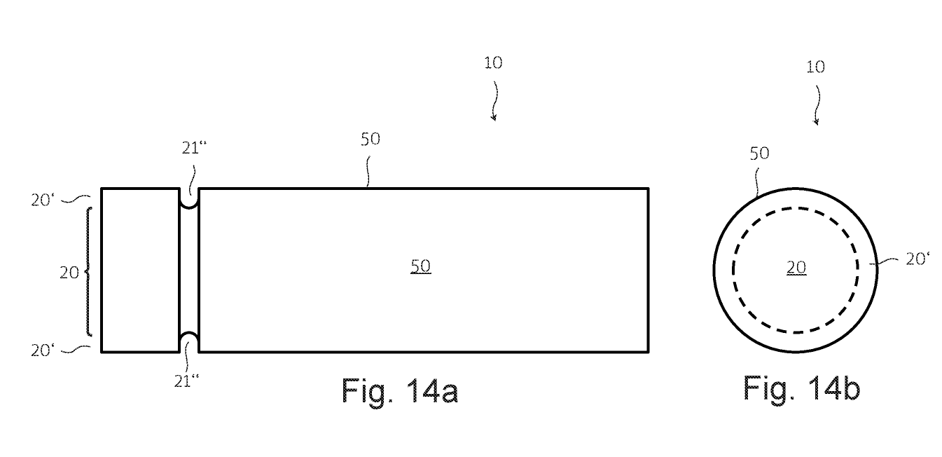

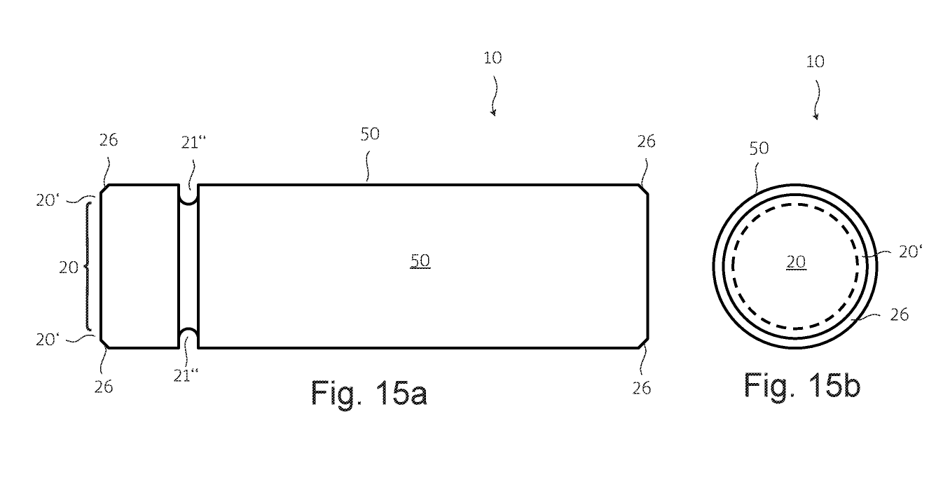

Referring to FIGS. 14a-14b and 15a-15b, the boundary of the light exit surface 20 can also be defined by a groove 21″ which does not adjoin the light exit surface. In this example, the groove 21″ can also be referred to as a circumferential slot. The groove 21″ typically extends tangentially or transversely with respect to the optical axis or with respect to the longitudinal axis of the laser medium. The groove 21″ is arranged in relation to the position along the optical axis in such a way as to suppress the formation of laser modes in the region of the groove 21″ parallel to the optical axis. The groove 21″ is accordingly aperture-effective, i.e. delimits the aperture to the light exit surface 20.

In this case the light exit surface 20 is accordingly not bounded by an edge. Rather, the end side of the laser medium comprises the light exit surface 20 as a partial surface. In other words, the light exit surface 20 undergoes transition precisely to a dead region 20′ of the end side of the laser medium.

Referring to FIGS. 15a-15b, chamfers 26 embodied as safety chamfers can furthermore be provided. In this case, the safety chamfers are each situated in the dead region 20′ of the end sides of the laser rod and are accordingly not aperture-effective.

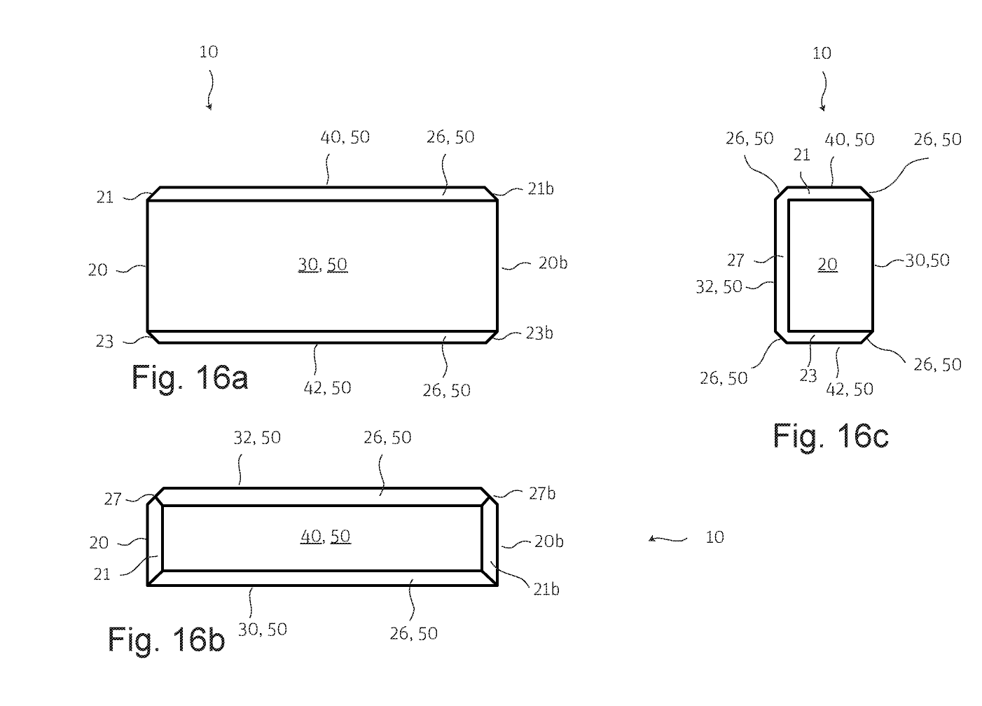

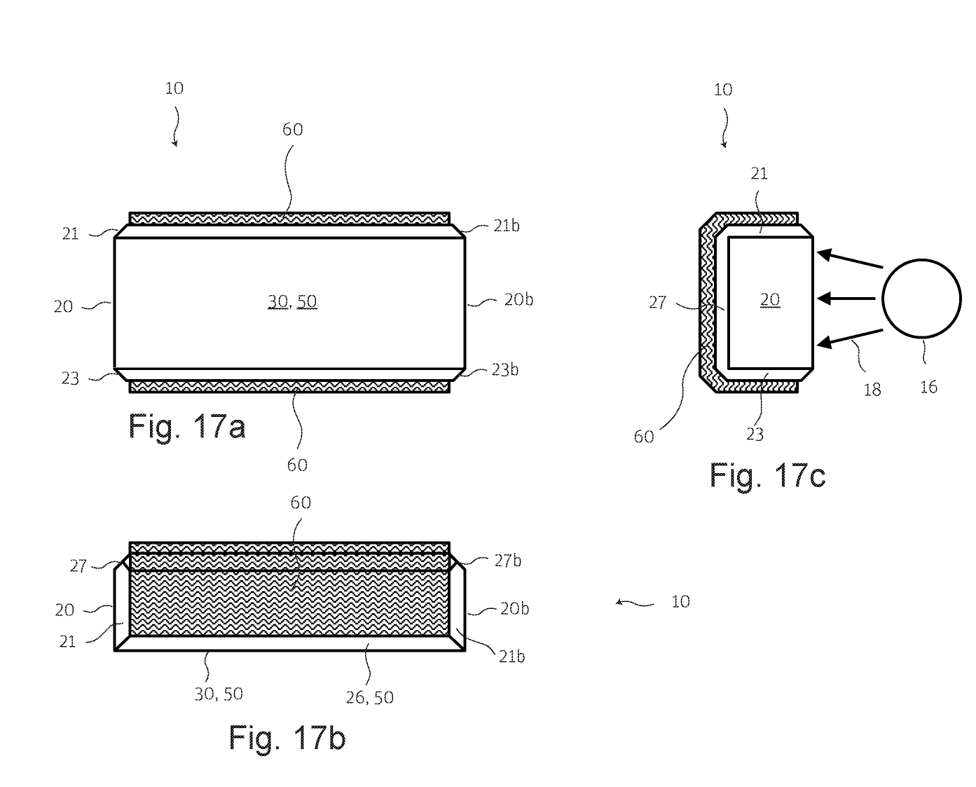

FIGS. 16a-16c and 17a-17c each show a laser medium 10 embodied as a laser rod in a side view (FIGS. 16a and 17a), a plan view (FIGS. 16b and 17b) and in a front view of the light exit surface 20 (FIGS. 16c and 17c).

Referring to FIG. 16a-16c, a side surface 30 can undergo transition to the light exit surface 20 via only one edge. In other words, this edge between the side surface 30 and the light exit surface 20 is not provided with a chamfer or a groove.

In general terms, provision can accordingly be made for a first boundary (here the right-hand straight edge section) of the light exit surface 20 to be defined by a side surface 30 of the laser medium, i.e. not by a chamfer or groove at or in the laser medium e.g. at or in said side surface 30.

Preferably, at the same time, at least one of the other boundaries or the other boundaries, which together with the first boundary define a boundary on all sides of the light exit surface 20 (here the upper, left-hand and lower edge sections), of the light exit surface 20 is/are defined by a chamfer (here the chamfers 21, 23, 27) or a groove.

Accordingly, the side surface 30 is larger than the opposite side surfaces 32. This may be advantageous in particular for introducing pump light. Accordingly, the side surface 30 is preferably embodied as a pump light surface or comprises a pump light surface.

Furthermore, chamfers 26 embodied as safety chamfers can be provided along the longitudinal axis of the laser medium in order to increase the fracture toughness. Accordingly, the lateral surface of the laser medium 10 here includes the side surface 30 serving as a pump light surface, the other side surfaces 32, 40, 42 and the chamfers 26.

Moreover, provision can be made for the laser medium to be mirror-symmetrical with respect to a plane perpendicular to the longitudinal axis. In particular, the laser medium 10 illustrated has respective light exit surfaces 20 and 20b on both end sides, wherein respective aperture-effective chamfers 21, 23, 27 and 21b, 23b, 27b (i.e. chamfers defining the boundary of the light exit surfaces) are provided.

FIGS. 17a-17c show the laser medium 10 from FIGS. 16a-16c, wherein the lateral surface 50 at least excluding the pump light surface is reflectively coated with a reflective coating 60. Accordingly, pump light 18 from a pump light source 16 can be coupled into the laser medium 10 via the side surface 30. As has been described above, the pumping efficiency can be increased by the reflective coating.

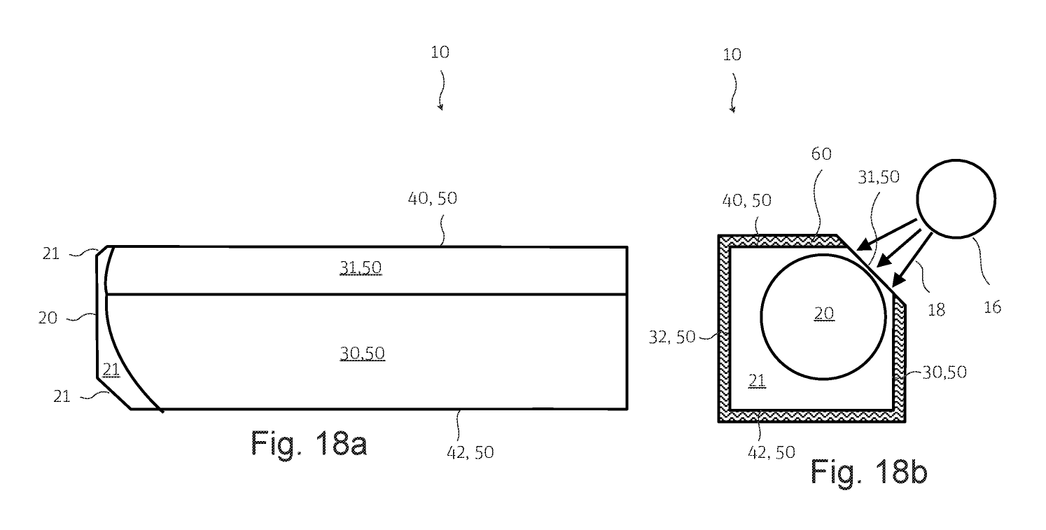

FIGS. 18a-18b shows a laser medium 10 embodied as a laser rod in a side view (FIG. 18a) and in a front view of the light exit surface 20 (FIG. 18b), wherein the laser medium 10 has a cone-shaped chamfer 21 (in a manner similar to that in FIGS. 5a-5c). The lateral surface 50 excluding a pump light surface is reflectively coated with a reflective coating 60, the reflective coating 60 not being illustrated in FIG. 18a for reasons of clarity.

With regard to production, provision can be made here firstly for a reflective coating 60 to be applied to at least one part of the laser medium 10, e.g. to at least one part of the lateral surface 50, and then for the pump light surface to be generated by a part of the reflective coating, in particular together with a part of the laser medium 10, being removed again. Furthermore, provision can be made for the at least one chamfer, here the cone-shaped chamfer 21, to be produced after the reflective coating 60 has been applied.

The pump light surface has been produced here e.g. by chamfering a longitudinal edge of the reflectively coated laser medium 10.

The laser medium 10 embodied as a laser rod here accordingly has a pentagonal cross section and five side surfaces 30, 31, 32, 40, 42, wherein the side surface 31 is embodied as a pump light surface.

The light exit surface 20 can be offset laterally, as here, in such a way that the light exit surface 20 is arranged nearer to the pump light surface than to a side surface or the other side surfaces of the laser medium 10. This can be advantageous since the energy density is typically the highest in the vicinity of the pump light surface.

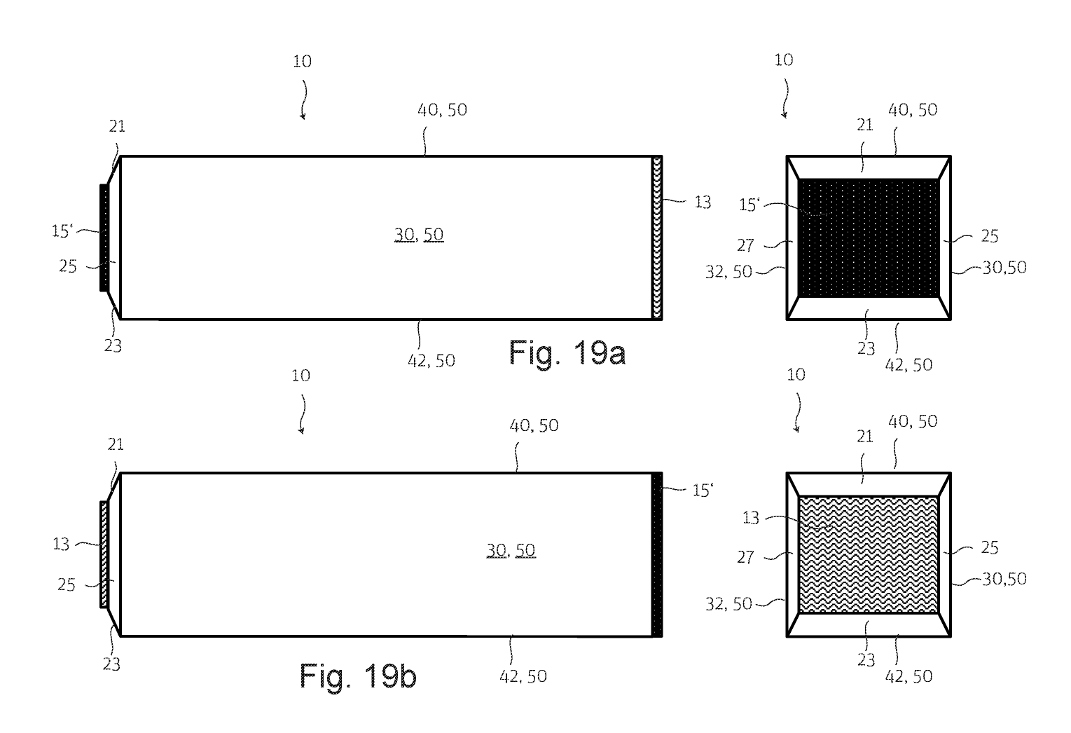

FIGS. 19a and 19b each show a laser medium 10 embodied as a laser rod in a side view (left) and in a front view of the light exit surface 20 (right).

The laser rod shown in FIG. 19a has a reflective coating 15′ on its chamfered end side, wherein the reflective coating can be embodied as a partly or a highly reflective coating. In other words, the chamfered end side of the laser rod is partly reflectively coated or reflectively coated. If the coating 15′ is a partly reflective coating, then the end face on the chamfered end side of the laser rod is typically embodied as a light exit surface. The end face of the laser rod situated opposite the chamfered end side has an antireflection coating 13.

Conversely, the laser rod shown in FIG. 19b has an antireflection coating 13 on its chamfered end side and a (partly) reflective coating 15′ on the opposite end face. If the coating 15′ is a partly reflective coating, the end face situated opposite the chamfered end side typically comprises a light exit surface (as partial surface).

In other words, in the case of laser rods having a reflectively coated or partly reflectively coated end face (and an uncoated or e.g. antireflection-coated opposite end face), the at least one chamfer (or groove) can be situated on either one or the other end side of the laser rod.

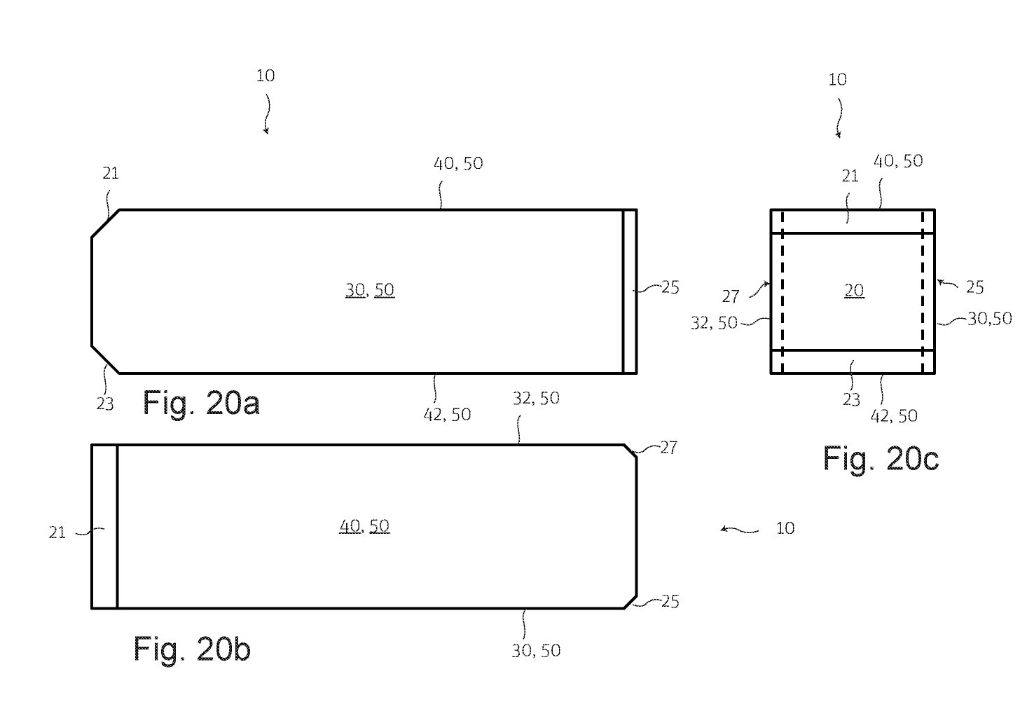

Referring to FIGS. 20a-20c, it is also possible, in particular, to provide chamfers (or grooves) on both end sides simultaneously, in such a way that a boundary of a light exit surface 20 is defined jointly by the chamfers (or grooves) of the chamfers (or grooves) provided on both end sides. In the example shown, the chamfers 21, 23 are situated on one end side and the chamfers 25, 27 on the other end side, wherein these two pairs of chamfers are arranged in a manner rotated by 90 degrees with respect to one another.

In the case of cylindrical geometries, as shown for instance in FIGS. 9a-9b, 10a-10b, 11a-11b, 12a-12b or 13a-13b, the laser rods shown in the exemplary embodiments have a cylinder diameter of 4 mm and a cylinder height of 60 mm. As explained above, it is also possible to produce significantly smaller cylindrical laser rods having for instance a cylinder diameter of just 1 mm or even only 0.7 mm and a cylinder height of 10 mm or even only 5 mm.

In the case of parallelepipedal laser rods as laser medium, as shown for instance in FIGS. 2a-2c, 3a-3c, 4a-4c or 5a-5c, 6a-6c, 7a-7c or 8a-8b, these have a parallelepiped length of 30 mm, a parallelepiped width of 5 mm and a parallelepiped height of 5 mm. Here, too, as explained above, significantly smaller parallelepipedal laser rods are possible, having for instance a parallelepiped length of 4 mm, a parallelepiped width of 2 mm and a parallelepiped height of 1 mm or a parallelepiped length of 3 mm, a parallelepiped width of 0.7 mm and a parallelepiped height of 0.7 mm. In this case, the A/V ratio is in a range of between 0.8 and 10, preferably between 1 and 8 and particularly preferably between 2 and 7.

Generally, embodiments larger than those described above are also possible. In this regard, by way of example, the length of the laser medium can be up to 250 mm or more, and said length can also be up to approximately 500 mm in further embodiments. Furthermore, the cross sections and/or the front side lengths of the laser medium can also be larger than those described above, for example can be up to 25.4 mm or more and, in further embodiments, up to 50 mm.

What may be of particular interest, however, is producing laser media comprising laser rods on the basis of phosphate glass which have the small dimensions mentioned above.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A laser medium for generating a laser light, the laser medium is in a solid state, and the laser medium comprises:
a light exit surface, through which the laser light exits from the laser medium during laser operation, and the light exit surface has a boundary which is defined by one of at least one chamfer and at least one groove.

2. The laser medium according to claim 1, wherein a ratio of a surface area to a volume of the laser medium is in between 0.8 and 10.

3. The laser medium according to claim 1, wherein the light exit surface has a boundary on all sides which is defined by one of the at least one chamfer and the at least one groove.

4. The laser medium according to claim 1, wherein during laser operation the light exit surface serves as an aperture and one of the at least one chamfer and the at least one groove serves as an aperture stop in order to shape a specific beam profile.

5. The laser medium according to claim 1, wherein during laser operation one of the at least one chamfer and the at least one groove serves to influence a mode profile during laser operation in a defined manner in order to at least one of bring about specific beam properties of the laser light and improve a beam quality of the laser light.

6. The laser medium according to claim 1, wherein the laser medium has a longitudinal axis, and the laser medium is embodied as a laser rod having a first end face including the light exit surface, a second end face opposite the first end face, and a lateral surface.

7. The laser medium according to claim 6, wherein the light exit surface is planar and extends at least one of perpendicularly to the longitudinal axis of the laser medium and parallel to the second end face of the laser rod.

8. The laser medium according to claim 6, further comprising a reflective coating applied on at least one of the second end face, the lateral surface, and one of the at least one chamfer and the at least one groove.

9. The laser medium according to claim 1, wherein the laser medium has a cross-sectional area which is uniform over a part of a length of the laser medium, perpendicular to a longitudinal axis of the laser medium.

10. The laser medium according to claim 1, wherein relative to a cross-sectional area perpendicular to a longitudinal axis of the laser medium, the light exit surface is at least one of smaller, is laterally offset, is geometrically dissimilar, and has a different number of vertices.

11. The laser medium according to claim 1, wherein the boundary which is defined by one of a circumferential chamfer and a circumferential groove.

12. The laser medium according to claim 1, wherein the light exit surface is rectangular and has boundaries which are defined by one of a plurality of chamfers and a plurality of grooves.

13. The laser medium according to claim 1, wherein the light exit surface is circular or elliptic and is bounded by a cone-shaped chamfer in such a way that the chamfer is defined by a surface on a cone whose axis extends parallel or obliquely with respect to a longitudinal axis of the laser medium.

14. The laser medium according to claim 1, wherein the light exit surface is geometrically dissimilar relative to a cross-sectional area perpendicular to a longitudinal axis of the laser medium.

15. The laser medium according to claim 1, further comprising a host material and, embedded therein, a laser-active material for a stimulated emission of photons, wherein the host material comprises one of glass and crystal.

16. The laser medium according to claim 15, wherein the host material is selected from a group of phosphate glasses, comprising phosphate glasses having a designation of one of LG960, LG950, and LG940.

17. The laser medium according to claim 15, wherein the laser-active material includes at least one of ytterbium ions, erbium ions, neodymium ions, praseodymium ions, samarium ions, europium ions, gadolinium ions, terbium ions, dysprosium ions, holmium ions, thulium ions, cerium ions, chromium ions, cobalt ions, vanadium ions, nickel ions, molybdenum ions, and titanium ions.

18. The laser medium according to claim 1, wherein at least one of a concentration of the ytterbium ions is in a range of 5×10²⁰ cm⁻³ to 30×10²⁰ cm⁻³, a concentration of the erbium ions is in a range of 0.1×10²⁰ cm⁻³ to 2×10²⁰ cm⁻³, a concentration of the chromium ions is in a range of 0 to 0.2×10²⁰ cm⁻³, and a concentration of the neodymium ions is in a range of 0.1×10²⁰ cm⁻³ to 10×10²⁰ cm⁻³.

19. A laser device, comprising:
a laser medium for generating a laser light, the laser medium is in a solid state, and the laser medium includes a light exit surface, through which the laser light exits from the laser medium during laser operation, and the light exit surface has a boundary which is defined by one of at least one chamfer and at least one groove;
a pump source for introducing pump light into the laser medium; and
a resonator for multiple reflection of photons, wherein the resonator includes one of an output coupling mirror formed by a partly reflective coating and an end mirror formed by a highly reflective coating.

20. A method for producing a laser, comprising:
providing a laser medium having a light exit surface, a lateral surface, and at least one edge, and the at least one edge forms a transition between the light exit surface and the lateral surface of the laser medium; and
chamfering the at least one edge by at least one of grinding, polishing, and milling away the at least one edge.
